(19) United States
(12) Patent Application Publication
(10) Pub. No.: US 2012/0038188 A1
(43) Pub. Date: Feb. 16, 2012

(54) FRONT PROTECTIVE MOLDING FOR AN AUTOMOBILE COMPRISING A REINFORCED CENTRAL PORTION

(75) Inventors: Hicham Challal, Versailles (FR); Olivier Veuillot, Limeil Brevannes (FR)

(73) Assignee: RENAULT S.A.S., Guyancourt Cedex (FR)

(21) Appl. No.: 13/145,005

(22) PCT Filed: Jan. 14, 2010
(86) PCT No.: PCT/FR2010/050053

§ 371 Date: Nov. 3, 2011

(30) Foreign Application Priority Data
Jan. 23, 2009 (FR) 0900306

(51) Int. Cl. B62D 25/08

(52) U.S. Cl. 296/193.09

(57) ABSTRACT

A front protective molding for an automobile to be installed on a front of an automobile structure that includes a front cross-member, the protective molding including a central portion capable of extending above the front cross-member and including a reinforcement for the central portion that includes a cross beam. The cross beam is deformable when a force greater than a predetermined value is exerted thereupon and the reinforcement includes at least one substantially vertical deformable bearing column capable of supporting the cross beam, and is arranged substantially above or on the front cross-member.

The present invention relates to a front bumper, or front protective molding, of an automotive vehicle, which makes it possible to reduce the injuries caused at the level of the top of the leg, and more particularly the hip of a pedestrian, when said pedestrian is knocked over by the vehicle.

The document FR 2 875 771 describes a front protective molding reinforcement, which comprises three parallel beams. These beams extend parallel to the front face of the vehicle, when the reinforcement is mounted on the rails of the latter. The presence of the three beams makes it possible to divide the energy of the impact into three regions which are arranged so that the knee of the pedestrian does not come into direct contact with the protective molding. These beams include a support on which is mounted a shock-absorbing element.

In an embodiment described in the above-mentioned document, the third beam can be arranged fairly high on the front of the vehicle, so as to come into contact with the hip of the pedestrian or the head of the pedestrian, if said pedestrian is a child or a small adult. The shock-absorbing element fitted on this beam makes it possible to dissipate at least a portion of the energy released on the impact, in order to reduce the injuries caused to the pedestrian.

One aim of the present invention is to propose a novel front protective molding structure which makes it possible to reduce the injuries likely to be caused to the upper part of the leg of a pedestrian (or to the head thereof, if the pedestrian is small), on a pedestrian impact.

This aim is achieved by means of a front protective molding for automotive vehicles, which can be mounted on the front of an automotive vehicle structure which comprises a front crossmember, said protective molding having a central portion which can be extended above said front crossmember and which can be arranged at the level of the free edge of the hood of said vehicle, said protective molding including a reinforcement for said central portion, said reinforcement comprising a crossbeam which extends substantially parallel to said central portion.

According to the invention, the crossbeam can be deformed when a force greater than a given value is exerted on it and said reinforcement includes at least one support frame, substantially vertical, which can be deformed when a force greater than a given value is exerted on it, said support frame is capable of supporting said crossbeam and of being arranged substantially above or on said front crossmember, by virtue of which, should a pedestrian be struck, said crossbeam deflects toward said support frame and transmits the forces to said support frame which is deformed, by bearing on said front crossmember, so as to dissipate a portion of the energy of the impact.

According to the invention, the support frame can effectively support the central beam or be positioned under the latter so as to come into contact with it, in case of impact only, for the transmission of the forces.

The number of frames is not limited according to the invention and depends on the size of the protective molding, in particular the dimension of the protective molding which corresponds to the width of the vehicle on which the protective molding may be mounted.

According to one embodiment, the reinforcement comprises at least one front frame, which extends in front of said support frame to form, with said support frame, an arch which extends perpendicularly to said crossbeam. Here too, this frame may or may not be securely attached to the beam, independently of whether or not the support frame is itself securely attached to the crossbeam. The front frame may be securely attached to the support frame.

Advantageously, the reinforcement comprises an anchoring strip, substantially parallel to said crossbeam and securely attached to the free end of said front frame, said anchoring strip makes it possible to mount said reinforcement behind said protective molding. This reinforcing strip also makes it possible to transmit the forces from the beam to all the front frames.

Advantageously, said front frame and said support frame form a single piece.

Advantageously, the front frame, the support frame and said crossbeam form one and the same piece.

According to one embodiment, the protective molding includes a rigid reinforcement, covered by a flexible skin.

According to one embodiment, said front frame is positioned directly under said skin and the free end of said front frame bears on a flange formed by said skin.

The protective molding may comprise a shock-absorbing element, which can be positioned between said front protective molding and said front crossmember.

The structures of the crossbeam, of the support frame and of the front frame are not limited according to the invention, as long as the latter allow them to be deformed, in particular in the event of a compression force.

According to one embodiment, the crossbeam and the support frame have a structure comprising ribs which enable them to be deformed. A corrugated structure, formed by multiple cells, may also be used without departing from the framework of the present invention.

Other particular features and advantages of the invention will emerge from reading the description given hereinbelow of a particular embodiment of the invention, given as a nonlimiting indication, with reference to the appended drawings in which:

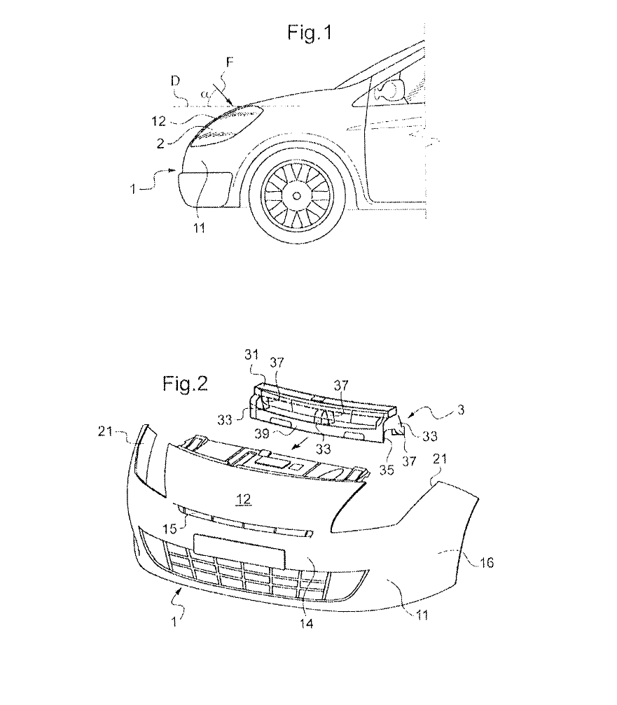

FIG. 1 represents a side view of the region of an automotive vehicle which comes into contact with the legs of a pedestrian, in the event of an impact;

FIG. 2 represents a perspective view of a particular embodiment of the invention;

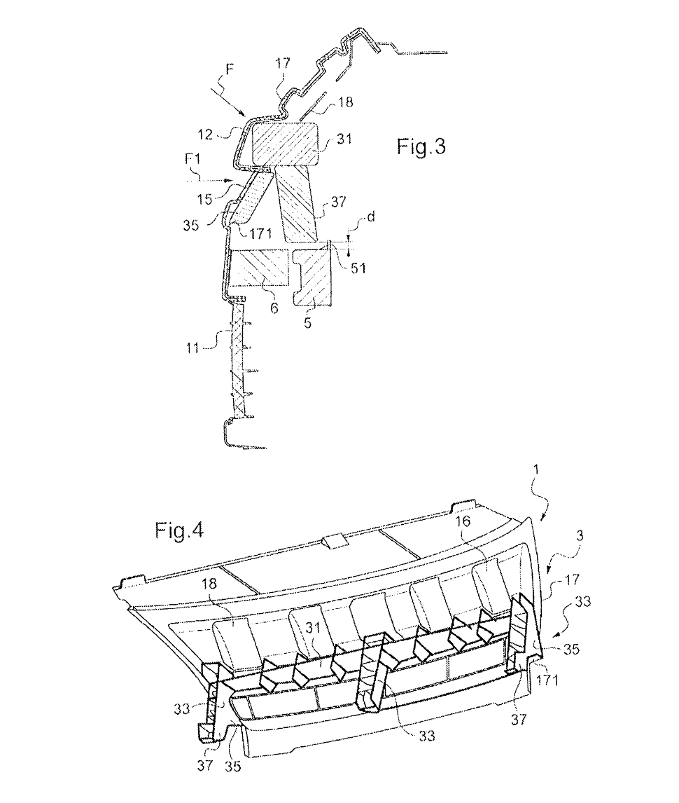

FIG. 3 represents a longitudinal cross-sectional view of the embodiment represented in FIG. 2;

FIG. 4 represents a partial view, in perspective, of the rear of the protective molding represented in FIGS. 2 and 3; and

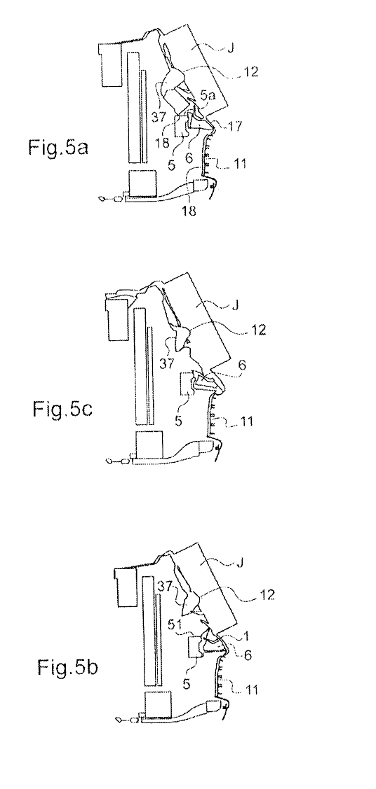

FIGS. 5a to 5c illustrate the deformations of the inventive protective molding, in the event of a pedestrian impact.

FIG. 1 represents a side view of the front portion of an automotive vehicle. This vehicle has a front protective molding 1 and two front headlights 2. The front protective molding 1 includes a central portion which extends between the two front headlights 2. D is used to define the longitudinal direction of the vehicle which is substantially horizontal and perpendicular to the front portion of the protective molding 1. In the event of a pedestrian impact, the top of the leg (or the hip) of the pedestrian exerts a force F on the protective molding, between the headlights 2. This force F forms an angle α, substantially equal to 45° with the direction D.

Referring to FIG. 2, a first embodiment of the invention will now be described.

The protective molding 1 includes a bottom portion 11, which extends under the openings 21 which are intended to receive the front headlights 2, on the assembled vehicle. A bottom air intake is formed in the bottom portion 11. The protective molding 1 also has a central portion 12, positioned between the abovementioned openings 21 and which extends substantially vertically, to the front edge of the hood, when the protective molding 1 is mounted on a vehicle. The protective molding 1 has an external face 14 and an internal face 16, facing toward the vehicle. A top air intake 15 is formed in the bottom portion of the central portion 12, between the openings 21. This top air intake 15 extends transversely to the central portion 12, between the two openings 21. A reinforcement 3 can be fixed on the internal face 16 of the protective molding, at the level of the central portion 12 thereof.

The reinforcement 3 comprises a crossbeam 31, which, when the reinforcement 3 is mounted on the protective molding 1, extends parallel to the top edge of the central portion 12, that is to say parallel to the free edge of the hood of the vehicle. Frames 33 extend under the crossbeam 31. The reinforcement 3 comprises, in the particular embodiment represented here, three frames 33, two of which are arranged at the ends of the crossbeam 31, and one of which is substantially in the middle of the crossbeam 31. Each frame 33 forms an arch which extends in a direction perpendicular to the crossbeam 31, that is to say longitudinally to the vehicle, when the protective molding 1-reinforcement 3 assembly is mounted thereon. The top of the arch is securely attached to the crossbeam 31. Each frame 33 is formed by a front frame 35, oriented toward the protective molding 1 and a support frame 37. The front frames 35 have a free end, opposite to the crossbeam 31. The free ends of the front frames 35 are linked by an anchoring strip 39, parallel to the crossbeam 31. This anchoring strip 39 serves, on the one hand, to transmit the forces to the frames 33 and, on the other hand, to mount the reinforcement 3 on the protective molding 1. In the embodiment represented here, the crossbeam 31 and the frames 33 form a single piece which is easy to clip or fit on the rear face 16 of the protective molding 1.

FIG. 3 represents a schematic view, in longitudinal cross section, of the protective molding of FIG. 2, when the reinforcement 3 is mounted behind the protective molding 1 and the duly formed protective molding is mounted on the structure of an automotive vehicle. The protective molding 1 is formed by a skin 17, relatively flexible and thin, made of plastic material. This skin 17 covers a rigid reinforcement 18 which is fixed to the structure of the vehicle. The structure of the vehicle includes a front crossmember 5 which extends transversely to the vehicle. This front crossmember 5 has a top face 51, oriented toward the reinforcement 3. A shock-absorbing element 6 is positioned in front of the front crossmember 5, between the front crossmember 5 and the internal face 16 of the protective molding 1. The crossbeam 31 of the reinforcement 3 is housed in a recess formed by the reinforcement 18, above the front crossmember 5 and the top air intake 15. The support frame 37 extends from the crossbeam 31 to the top face 51 of the front crossmember 5. The support frame 37 has a ribbed structure which enables it to be deformed (see FIG. 4). The free end of the support frame 37 is arranged at a short distance D, of around 5 to 10 mm, above the top face 51 of the front crossmember 5. The front frame 35 extends from under the crossbeam 31, to the internal face 16 of the protective molding 1. The front frame 35 is positioned under the skin 17 of the protective molding 1, which at this point does not include any reinforcement 18. The front frame 35 extends substantially vertically through the top air intake 15. Its free end is positioned above the shock-absorbing element 6, on a substantially horizontal flange 171, formed by the skin 17. The front frame 35 is substantially shorter than the support frame 37 and its structure is also ribbed in order to enable it to be deformed. The front frame 35 also has a lesser rigidity than that of the support frame 37.

As represented in FIG. 4, the crossbeam 31 has a ribbed structure. It comprises a main rib, horizontal, which extends parallel to the protective molding 1 and a plurality of vertical ribs, spaced along the main rib and securely attached thereto. The frames 33 also have a ribbed structure which enables them to be deformed. The two end frames 33 form the ends of the crossbeam 31. The support frame 37 and the front frame 35 form one and the same piece, linked to the main rib of the crossbeam 31. The anchoring strip is no longer visible in this figure. The front frame 35 bears on the flange 171 formed by the skin 17.

According to another embodiment, the crossbeam 31 and/or the frames 33 can have a corrugated structure which also enables them to be deformed.

The operation of this particular embodiment will now be described with reference to FIGS. 1 to 5.

In FIG. 5, the leg of the pedestrian is represented by the cylinder J.

As represented in FIG. 5a, the leg J comes into contact with the central portion of the protective molding 1 at an angle of approximately 45°. Initially, as represented in FIG. 5a, the shock-absorbing element 6 absorbs a portion of the energy of the impact, at the same time as the front frames 35 which fold under the effect of the force exerted by the leg J (compression force). The anchoring strip 39 makes it possible to transmit the forces to all the front frames 35. Then, as represented in FIGS. 5a and 5b, the crossbeam 31 deflects (working in compression) toward the front crossmember 5, which causes the support frames 35 to be deformed. The latter are displaced, first of all, toward the front crossmember 5 (by the distance d) then bear on the top face 51 thereof. Their displacement by the distance d makes it possible to dissipate a portion of the energy of the impact. Their deformation, once they are bearing on the front crossmember 5, makes it possible to dissipate another (greater) portion of the energy of the impact.

In FIG. 5b, the frame 33 is completely deformed. Then, as represented in FIG. 5c, it is all the rest of the protective molding 1 which is deformed.

The transition from the normal state of the protective molding 1 to the configuration represented in FIGS. 5a and 5b is very rapid. The deformations of the skin 17, of the frames 33 and of the crossbeam 31 make it possible to dissipate the greater portion of the energy released during the impact. Thereafter in the impact, as represented in FIG. 5c, the forces are limited in intensity to a level which is not damaging to the leg of the pedestrian.

As an indication, just the deformation of the skin 17, of the anchoring strip 39 and of the front frames 35 makes it possible to dissipate approximately 150 KJ on an impact which releases a total of 450 KJ.

When the leg J comes directly into contact with the protective molding 1, at the level of the crossbeam 31, the latter deflects first toward the crossmember 5. The forces that are exerted on the beam 31 are transmitted to the frames 33 which first of all are displaced toward the front crossmember 5 then bear on the latter. They are then deformed, as explained previously, under the effect of the compression. In this case, the presence of the front frames 35 makes it possible to dissipate, because of their deformation, a certain quantity of energy.

In the case where it is the front frames that work first, their presence makes it possible to make the crossbeam 31 work without the latter being directly struck in the impact (case of an impact according to the arrow F1 represented in FIG. 3). The protective molding according to the invention is thus effective regardless of the initial point of impact and the direction of impact.

1-9. (canceled)

10. A front protective molding for automotive vehicles, which can be mounted on a front of an automotive vehicle structure that includes a front crossmember, the protective molding comprising:
a central portion that can be extended above the front crossmember and that can be arranged at a level of a free edge of a hood of the vehicle, the protective molding including a reinforcement for the central portion, the reinforcement including a crossbeam that extends substantially parallel to the central portion,
wherein the crossbeam is configured to be deformed when a force greater than a given value is exerted on it,
wherein the reinforcement comprises at least one support frame, substantially vertical, configured to be deformed when a force greater than a given value is exerted on it, and
wherein the support frame is configured to support the crossbeam and to be arranged substantially above or on the front crossmember, by virtue of which, should a pedestrian be struck, the crossbeam deflects toward the support frame and transmits forces to the support frame that is deformed by bearing on the front crossmember, so as to dissipate a portion of energy of the impact.

11. The protective molding as claimed in claim 10, further comprising at least one front frame, which extends in front of the support frame to form, with the support frame, an arch that extends perpendicularly to the crossbeam.

12. The protective molding as claimed in claim 11, further comprising an anchoring strip, substantially parallel to the crossbeam and securely attached to a free end of the front frame, wherein the anchoring strip makes it possible to mount the reinforcement behind the protective molding.

13. The protective molding as claimed in claim 11, wherein the front frame and the support frame form a single piece.

14. The protective molding as claimed in claim 11, wherein the front frame, the support frame, and the crossbeam form one and a same piece.

15. The protective molding as claimed in claim 10, wherein the protective molding includes a rigid reinforcement, covered by a flexible skin.

16. The protective molding as claimed in claim 15, wherein the front frame is positioned directly under the skin and a free end of the front frame bears on a flange formed by the skin.

17. The protective molding as claimed in claim 10, further comprising a shock-absorbing element, which can be positioned between the front protective molding and the front crossmember.

18. The protective molding as claimed in claim 10, wherein the crossbeam and the support frame have a structure comprising ribs that enable them to be deformed.
